(19) United States
(12) Patent Application Publication
(10) Pub. No.: US 2005/0052465 A1
(43) Pub. Date: Mar. 10, 2005

(54) Wireless keyboard, video, mouse device

(76) Inventors: Richard L. Moore, Escondido, CA (US); Iain Huntly-Playle, La Jolla, CA (US); Kenneth R. Christoffersen, Poway, CA (US); Kevin M. McCafferty, San Marcos, CA (US); Greg Burke, Vista, CA (US); Rudolph J. Timmerman, Prairie Grove, AR (US); Gregory M. Garner, Springdale, AR (US); C. David Covington, Fayetteville, AR (US); Timothy D. Foster, Springdale, AR (US)

Correspondence Address: DAVIDSON BERQUIST JACKSON & GOWDEY LLP, 4501 NORTH FAIRFAX DRIVE, SUITE 920, ARLINGTON, VA, 22203, US

(21) Appl. No.: 10/883,993

(22) Filed: Jul. 6, 2004

Related U.S. Application Data
(60) Provisional application No. 60/484,541, filed on Jul. 3, 2003.

(51) Int. Cl. G09G 5/02

(52) U.S. Cl. 345/603

(57) ABSTRACT

A wireless keyboard, video, mouse (KVM) system includes transmitting compressed video signals. Analog video data is converted from RGB signals to YUV signals which are compressed using a linear interpolation algorithm.

### RELATION TO OTHER APPLICATIONS

This application claims priority from co-pending provisional U.S. patent application No. 60/484,541, filed Jul. 3, 2004, titled “Crystal Link Wireless Keyboard, Video, Mouse (KVM) Devices,” the contents of which are fully incorporated herein by reference.

### FIELD OF THE INVENTION

This invention relates to keyboard, video and mouse (KVM) systems. More specifically, this invention relates to wireless-based KVM systems.

### BACKGROUND

Systems exist to facilitate remote control of a computer by an operator at a different computer. Such systems typically use device that enable an operator at a remote computer to control aspects of a target computer. More particularly, such systems typically allow a remote computer to provide mouse and keyboard input to the target computer and further allow the remote computer to view the video display output of the target computer. Additionally, in cases where the target computer has a mouse and keyboard, their operation is reflected on the display at the remote computer. These types of systems are typically called keyboard-video-mouse (KVM) systems.

A typical KVM system 100 is shown in FIG. 1, where a target computer 102 is controlled by a remote computer 104. The remote computer 104 includes a keyboard 106, a video monitor 108 and a mouse (or similar point-and-click device) 110. The operation of the target computer 102 may be remotely viewed on the video monitor 108 of the remote computer 104, and the keyboard 106 and mouse 110 of the remote computer 104 may be used to provide keyboard and mouse input to the target computer 102. In a typical KVM system, a remote computer is able to control more than one target computer, for example, using a switch or some other mechanism. The remote computer, in a typical system, may be located within several hundred feet of the target computers.

Traditional KVM systems rely on wired technology to connect remote and target computers. It is, however, sometimes desirable to allow wireless connection between remote and target computers.

In order for a remote computer to control the operation of a target computer, it is desirable that the video display of the remote computer keep up, in essentially real-time, with the display of the target computer. However, large amounts of data are required to keep the remote computer's video display current. Accordingly, it is desirable to efficiently compress the video data being sent from the target computer to the remote computer.

### BRIEF DESCRIPTION OF THE DRAWINGS

For a more complete understanding of the present invention and the advantages thereof, reference should be made to the following Detailed Description taken in connection with the accompanying drawings, in which:

FIG. 1 depicts the components of a typical KVM system;

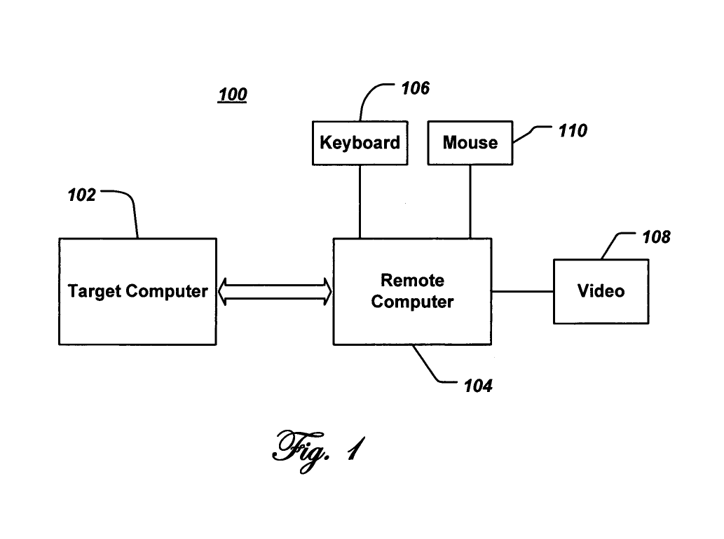

FIG. 2 depicts a KVM system according to embodiments of the present invention;

FIG. 3 shows certain details of a local unit of FIG. 2, according to embodiments of the present invention;

FIG. 4 shows certain details of a local/target FPGA (field programmable gate array) of FIG. 3, according to embodiments of the present invention;

FIG. 5 shows certain details of a remote unit of FIG. 2, according to embodiments of the present invention;

FIG. 6 shows certain details of a remote FPGA of FIG. 5, according to some embodiments of the present invention;

FIG. 7 graphically demonstrates the size of a FIFO that is needed for a video input bus for certain embodiments of the present invention;

FIGS. 8(a) and 8(b) show graphs of sample compression factors gained according to embodiments of the present invention;

FIG. 9 shows certain data formats according to embodiments of the present invention; and

FIGS. 10(a)-10(c) depict operation of the compression algorithm according to embodiments of the present invention.

### DETAILED DESCRIPTION OF PRESENTLY PREFERRED EXEMPLARY EMBODIMENTS OF THE INVENTION

The present invention provides wireless KVM systems and mechanisms that support such systems. In the discussion that follows, the computer or system being controlled is generally referred to as the target computer or the target system. In some instances, the target computer is also referred to as the local computer. The computer that is being used to control the target (local) computer is generally referred to herein as the remote computer or the remote system. For convenience of description, components on or connected directly to the target computer are referred to herein as “local”, whereas components that are on or connected directly to the remote computer are referred to herein as “remote.”

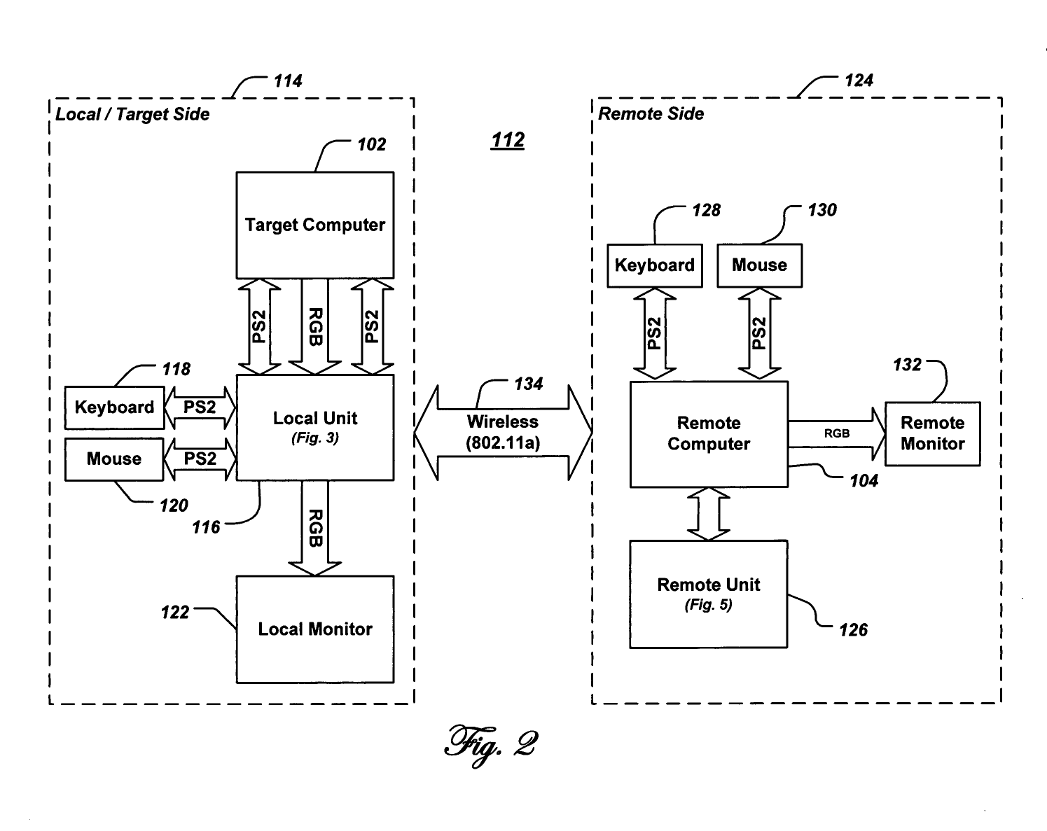

FIG. 2 shows a KVM system 112 according to embodiments of the present invention. The local side 114 includes a target computer 102 and a local unit 116. The local side 114 may also include a keyboard 118, a mouse (or other point-and-click-type device) 120 and a local monitor 122. The remote side 124 includes a remote computer 104 and a remote unit 126. Additionally, the remote side 124 includes a keyboard 128, a mouse (or other point-and-click-type device) 130 and a remote monitor 132. The local or target computer 102 may be a computer, a server, a processor or other collection of logic elements. The local and remote monitors 122, 132, may be digital or analog.

The local unit 116 is a device or mechanism that is installed locally to the target/local computer 102. This device may be close to, but external to the computer, or may be installed inside the computer. Regardless of the positioning of the local unit, there will preferably be a direct electrical connection between the target computer 102 and the local unit 116.

Various components on the local/target side 114 communicate wirelessly with components on the remote side 124. The wireless connection 134 preferably follows the IEEE 802.11 a standard protocol, although one skilled in the art will realize that other protocols and methods of wireless communication are within the scope of the invention.

As shown in FIG. 2, the local unit 116 obtains local mouse and keyboard signals, preferably as PS2 signals. These signals are provided by the local unit 102 to the target computer 102. The target computer 102 generates video output signals, preferably RGB (Red, Green, Blue) signals, which are provided to the local unit 116 which, in turn, provides the signals to drive the local monitor 122. As noted, the target computer 102 need not have a keyboard, mouse or monitor, and may be controlled entirely by a remote computer.

Local unit 116 compresses and transmits image and/or mouse and keyboard data for transmission to a remote system (e.g., remote computer 104). Additionally, local unit 116 may receive and decompress data (from a remote system), which is then provided to the local/target computer 102. The target computer 102 may execute the data received and may display output on its local monitor 122.

The remote side 124 receives video data from the local unit 116 of the target computer 102, preferably wirelessly (e.g., via an 802.11a wireless connection 134). The remote unit 126 receives compressed KVM data (as noted, not all of the KVM data need be compressed) from the local unit 116. The remote unit 126 decompresses the KVM data from the local unit 116 and provides it to the remote computer 104 which displays the video data, as appropriate, on remote monitor 132. Additionally, remote mouse 128 and keyboard 130 may be used to generate appropriate signals (e.g., PS2 signals) that may be transmitted via remote unit 126 to local unit 116 for execution on target computer 102.

In some embodiments, the target computer 102 and/or the remote computer 104 produce RGB video output signals.

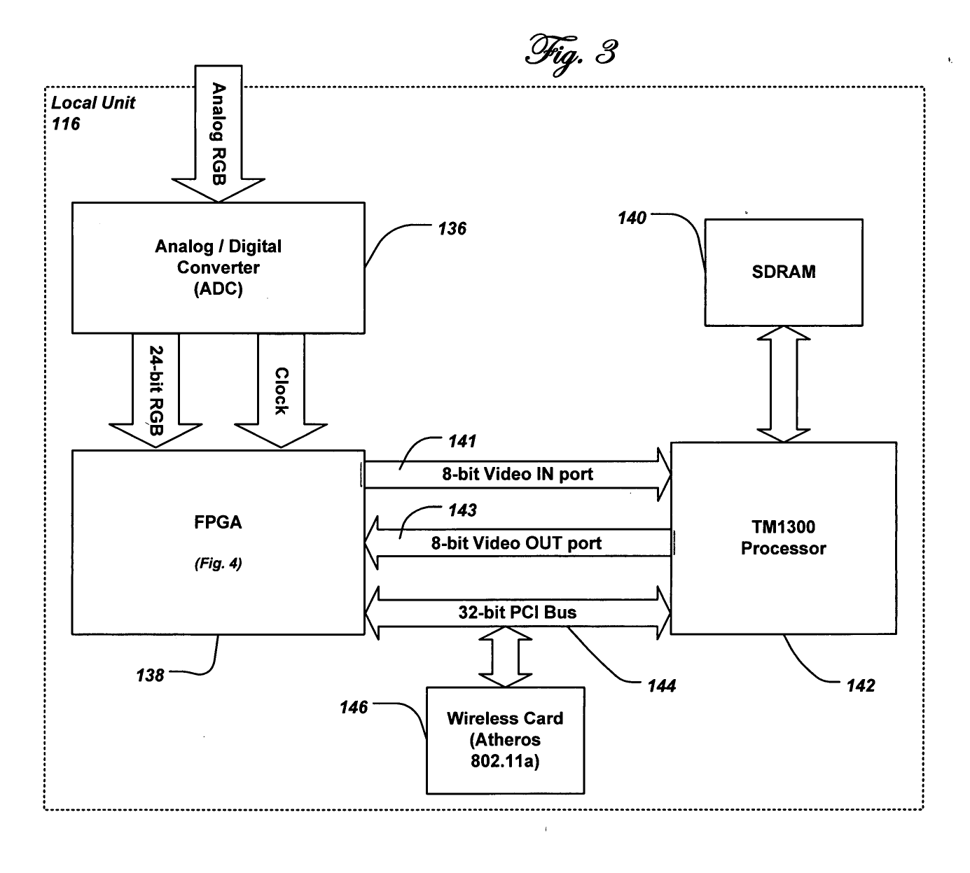

FIG. 3 shows certain details of a local unit 116 of FIG. 2, according to embodiments of the present invention. As shown in FIG. 3, local unit 116 includes an analog-to-digital video converter (ADC) 136, an FPGA 138 (preferably a Xilinx FPGA or the like), and a SDRAM 140 connected to a TM1300 processor 142. The FPGA 138 is connected to the TM1300 processor 142 by a 32-bit PCI bus 144. A wireless card (preferably an Atheros 802.11a card or the like) 146 is connected to the bus 144.

Analog RGB signals (from target computer 102, FIG. 2) are input to the ADC 136 which converts them to 24-bit RGB digital signals. The digital RGB signals are provided to the FPGA 138 along with a clock signal.

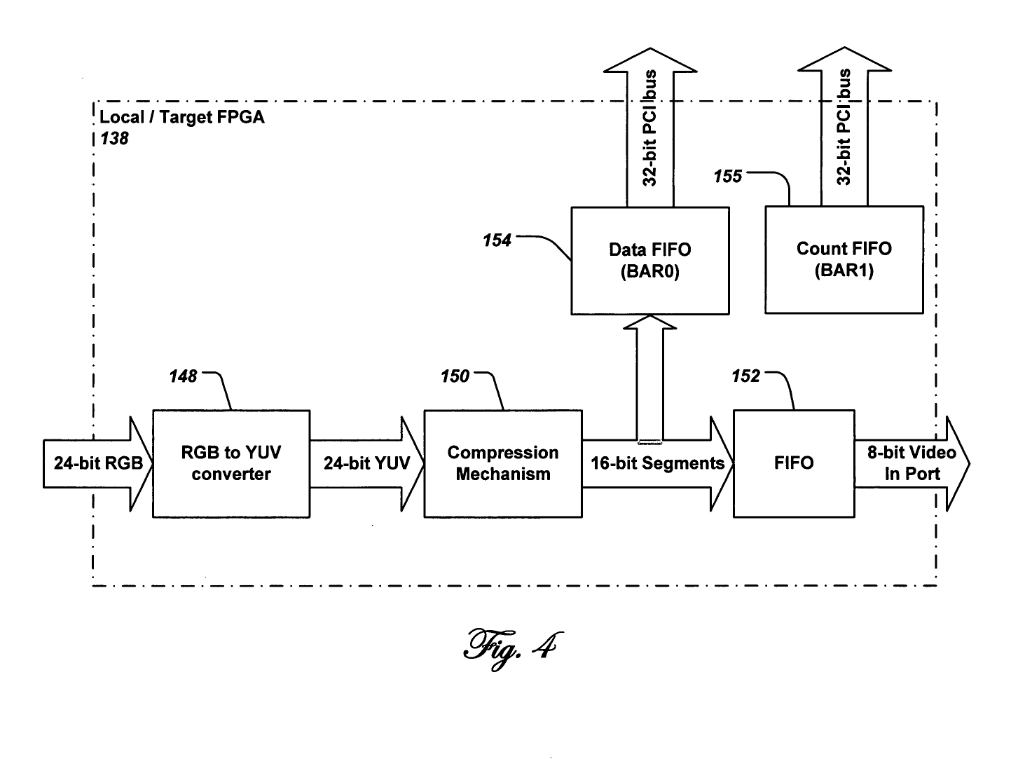

The FPGA/TM1300 interface preferably uses compressed data. FIG. 4 shows certain details of embodiments of a local/target FPGA. The FPGA 138 in the local unit 116 takes 24-bit RGB digital information and compresses this information (inside the local FPGA 138, as described below), into 16-bit linear fit YUV line segments using RGB to YUV converter 148 and a compression mechanism 150. YUV encoding schemes are well known in the art of digital video.

The RGB to YUV converter 148 may be constructed using a pipelined adder tree to implement the required multiplication and division. The output of the converter 148 (24-bit YUV values) is input to a compression mechanism 150 which generates compressed 16-bit line segments. The output of the compression mechanism 150 is input to a FIFO 152 that provides 8-bit video input to the TM1300 processor 142 (FIG. 3).

The compressed segments consist of a mix of absolute 5Y5U5V [??]data points and 16-bit relative line segments that contain a length and a delta for each of YUV. The worst case compression ratio occurs when each segment is an absolute segment, and the ratio is 24:16 (3:2). For a 1024 pixel input line (3×1024 bytes), the maximum output information in bytes is therefore 2048 bytes.

The TM1300 processor 142 has an 8-bit video-in port 141 that may run up to 81 MHz, and so it is used to transfer as much data as possible. The compressed data is transferred from the local FPGA 138 to the processor 142 using the video-in port 141 first. However, if the data will not fit, the remainder of the data for a particular line is transferred using the PCI bus 144.

The TM 1300 processor 142 also has an 8-bit video-out port 143 that can also run up to 81 MHz. This port can be used on the local unit 116 to allow the FPGA 138 to do frame-to-frame comparisons by sending the previous frame back to the FPGA while the FPGA is capturing the current frame. The FPGA can do a line-by-line comparison of the frames and report to the processor 142 the first and last pixels that are over a (programmable) threshold away from each other in Y, U, or V. This allows for the detection of changes, in real time, from frame-to-frame, without burdening the processor with pixel-by-pixel comparisons. In some embodiments the hardware imposes a limitation on the number of cycles per line available on the Video In and Video Out ports 143, 144, e.g., 1,344 clock cycles per line. In such case, if a line exceeds the limit (e.g., is greater than 1,344 bytes), then the TM1300 processor will have to compare the rest of that line after the maximum number of bytes (e.g., 1,344 bytes).

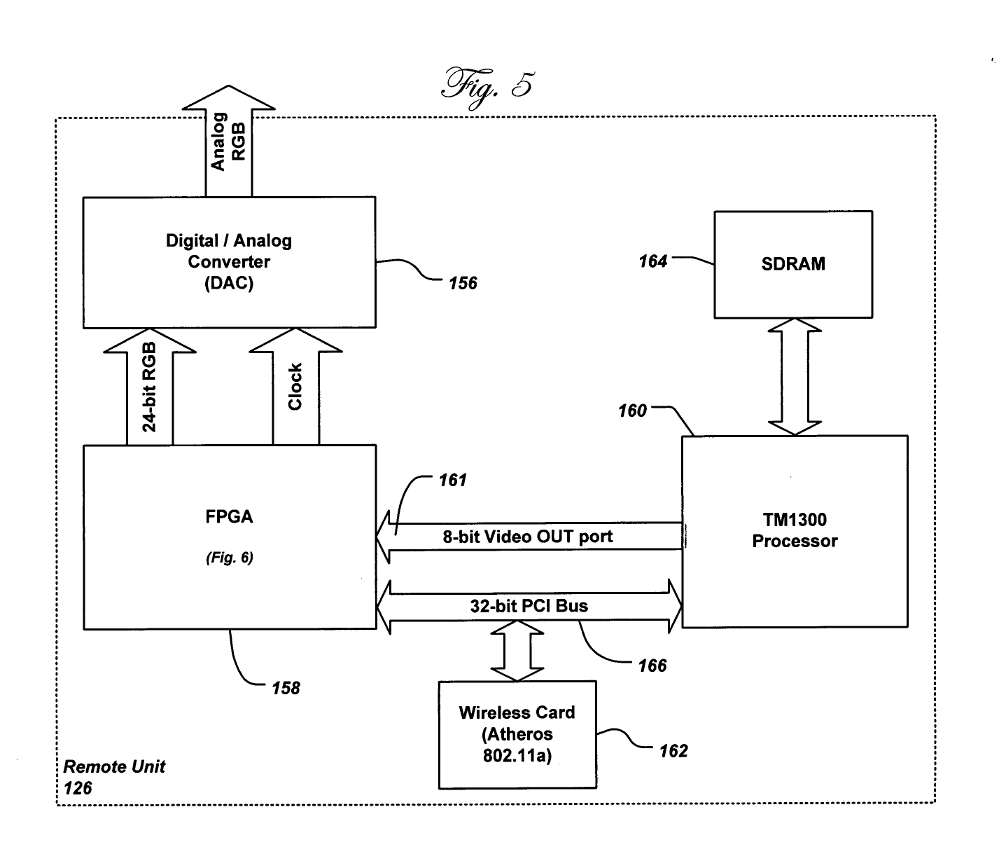

FIG. 5 shows certain details of a remote unit 126 of FIG. 2, according to embodiments of the present invention. As shown in FIG. 5, remote unit 126 includes a digital/analog converter (DAC) 156, an FPGA 158 (preferably a Xilinx FPGA or the like), a TM1300 processor 160 and a wireless card 162 (preferably an Atheros 802.11 a or the like). One skilled in the art will realize that the wireless card 162 must be compatible with the wireless card 146 on the target side 114). The TM1300 processor 160 is connected to an SDRAM 164.

The remote side (remote unit 126) gets a frame of data from the wireless card 162 and puts that frame into the SDRAM 164 of the TM1300 processor 160. The processor 160 then transfers the video data out through its 8-bit video-out port 161 (in some preferred embodiments at 1,344 data elements per horizontal line, and 768 active lines). Any data that can not fit in the bandwidth of the 1,344 clock cycles per horizontal line is transferred over the PCI bus 166 from the processor 160 to the FPGA 158.

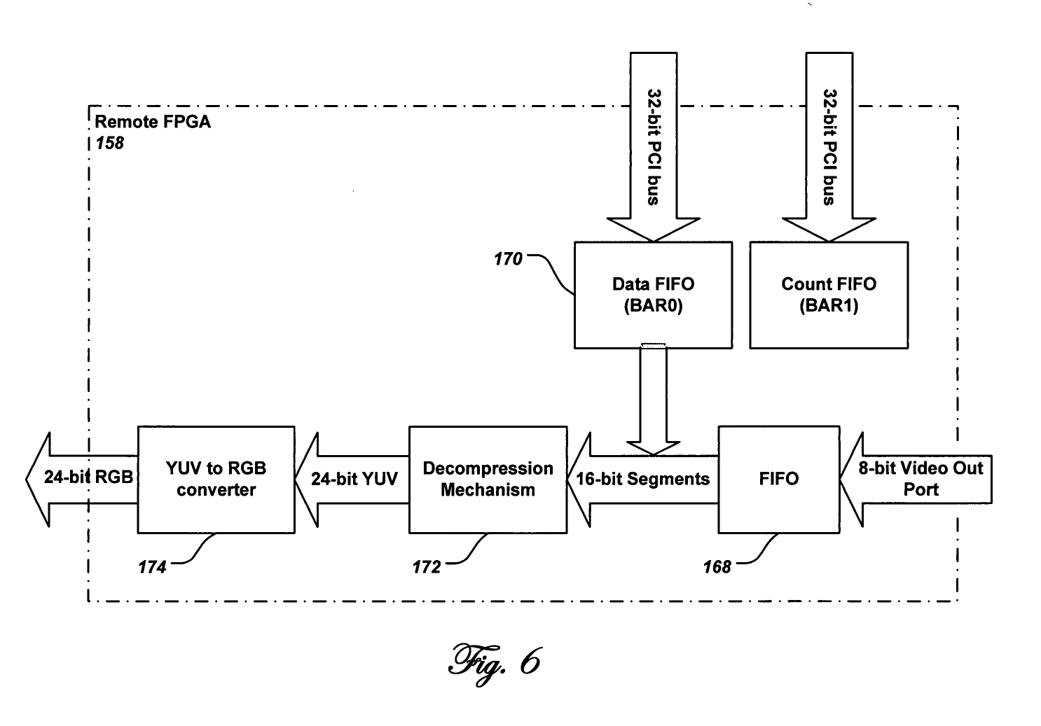

FIG. 6 shows certain details of a remote FPGA 158 (of FIG. 5), according to some embodiments of the present invention. As shown in FIG. 6, the remote FPGA 158 includes a FIFO 168 connected to the 8-bit video out port of the TM1300 processor 160. Additionally a data FIFO 170 is connected to the 32-bit PCI bus 166 in order to obtain data from the TM1300 processor 160. Sixteen-bit segments from the FIFO 168 (or the data FIFO 170) are input to a decompression mechanism 172 which produces 24-bit YUV output which is, in turn, input to a YUV-to-RGB converter 174. The converter 174 produces 24-bit RGB signals as output.

Data from the local side is transmitted from the local unit to the remote unit one line at a time, even if a line is longer than 1,344 bytes. This is necessary in order to allow the software that will cut and paste line segments from the frame-to-frame algorithm into the remote frame buffer. When each frame is sent, then the local side will send over the number of bytes for each line. The remote unit will then look at this data and it will know that any elements over 1,344 bytes will be copied to the BAR0 FIFO 170 in the remote FPGA.

The remote end will then receive, via the Video In port, 1,024 bytes at a time. When each 1,024 bytes is received, it will be copied into the appropriate address in the Video Out buffer. In preferred embodiments the Video Out buffer (associated with the Video Out port) is laid out as follows:

| Address | Content |
|---|---|
| 0*1344 | AAAA |
| . . . | |
| 25*1344 | AAAA (this is the sync width plus BP width) |
| 26*1344 | ABS [ABS or REL] [ABS or REL] . . . [ABS or REL] |
| | AAAA |
| 27*1344 | ABS [ABS or REL] [ABS or REL] . . . [ABS or REL] |
| | AAAA |
| 28*1344 | ABS [ABS or REL] [ABS or REL] . . . [ABS or REL] |
| | AAAA |
| 793*1344 | ABS [ABS or REL] [ABS or REL] . . . [ABS or REL] |
| | AAAA |
| 794*1344 | AAAA (this is the FP, which has a length of 1 line) |

Where “AAAA” is fill data that is “don't care”. The “AAAA” data is not transferred over the wireless link and it does not matter what value “AAAA” takes.

The active video starts on line 26 because VS_SYNC_WIDTH+VS_BACK_PORCH=26.

The Video Out buffer cannot be packed in the same way as the Video In buffer because there is not enough memory in the remote FPGA 158 to handle the worst case frame (which would require more than half the entire frame to be buffered inside the FPGA, waiting for the proper time to clock out the uncompressed pixels).

Since the received buffer Video In buffer is packed and the Video Out buffer cannot be packed, the transmitting code inside the TM1300 processor must perform the unpack function.

Once the TM1300 processor has the data unpacked at the appropriate addresses, it will be automatically transferred over the Video Out bus to the FPGA, at the same 81 MHz maximum rate that it was captured. The remote side may need to transfer the same frame out more than once (since the maximum capture speed is thirty (30) frames per second (FPS). In such an embodiment, the remote side must display sixty FPS. Preferably the pixel count of 1,344 pixels is fixed on the remote side (when using XGA), since this value will reliably drive most video monitors.

On the remote side, the Video Out data is sent one line before it is needed. The FIFO PCI data is sent out at the beginning of the frame (which is about twenty lines before it is needed). Note that the FIFO 170 on the FPGA will be reset when the VS signal occurs. Unlike the Video Out memory, the PCI FIFO on the remote side can be packed (since the FPGA will indicate to the TM1300 processor when it needs more data).

The FPGA will also have a count FIFO 171 where the TM1300 processor stores the number of compressed data elements that are put into the FIFO 170 only.

During the decompression process, the FPGA 158 examines the count FIFO 171 to see if there are data segments in the FIFO 170 for this line. The FPGA first transfers up to 1,344 elements of data from the Video Out FIFO in the decompression mechanism 172. If there are any data elements in the FIFO 170 for this line, it will append them to the video out transferred data. Note that the Video Out data could have been less than 1,344 (such as 1,300) if there were fewer pixel clocks per line on the local side.

In preferred embodiments, the amount of memory required in the remote FPGA is:
8 for data FIFO (2048×16,1024×32)
2 for decompression
1 for packet size FIFO (256×16)
3 for line buffer (512×8,256×16)
14 Total

It is desirable that the remote unit send some sort of acknowledgement handshake back to the local unit when it is ready to receive a frame.

The number of pixel clocks per video line can be set for the ADC 136 (in the local unit 116). A setup program may be used to tells the video ADC 136 the number of pixel clocks per video line. In presently preferred embodiments, this number is nominally 1,344 clocks per video line. However, the number may be changed, depending on the video quality when capturing data, and it may be more or less than that amount. The FPGA 138 may be told how many cycles per video line are being used, and this number can be used inside FPGA 138. However, the number of clocks per video line on the remote side must also be considered. The number of pixel clocks per video line should not be set to more than that value used on the remote side. So, if there are more than 1,344 clocks per video line, the fact that the remote side has exactly 1,344 clocks per video line must be considered, and, in that case, software that sets the register should never set it to more than 1,344.

In the following analysis, it is assumed that the clocks per video line is set to 1,300. Because the local FPGA will always have 1,300 or more pixel clocks per line (when using XGA), the video-in bus can always transfer 650 two-byte elements per line (1,300 bytes). Therefore, using these numbers, in the worst case scenario, the PCI bus 144 will be used to transfer only 374 compressed pixel elements (748 bytes) per line.

Data transferred over the video-in bus 141 (on the local side 116, from the FPGA 138 to the processor 142) shows up in a buffer of SDRAM 140 of processor 142. This happens automatically and without processor intervention other than setting up the video-in registers on the FPGA 138 and the video bus. The extra data that is transferred over the PCI bus 144 is moved using the DMA mechanism inside the video bus. This data will be accumulated inside a dual port RAM (DPR) inside the FPGA 138. This DPR is preferably configured as a FIFO.

The DPR begins sending data out on the first clock cycle after an HSync signal is detected. It will then send out one byte per clock cycle, until all 1,300 bytes have been transmitted. The same DPR will get written to when the compression mechanism 150 starts working on approximately the 150th pixel clock after the HSync signal is detected. The compression mechanism 150 may put in 16 bits per clock, up to 1,300 bytes.

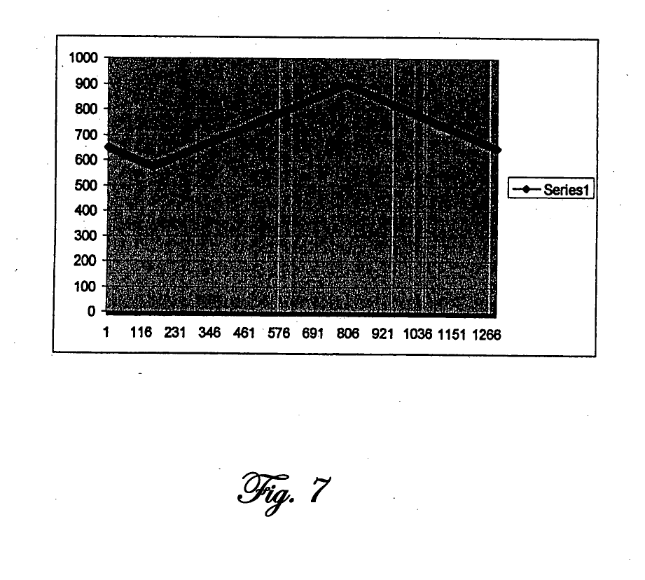

FIG. 7 graphically demonstrates a determination of the size of the FIFO that is needed for the video-in bus in certain embodiments. In the graph, the Y-axis represents the number of words required and the X-axis represents the clock cycle. From the graph, it may be seen that the FIFO size required is 900 words, or 1,900 bytes. This graph shows that at the beginning of the line, the FIFO contains 648 words of data to be sent over the video-in bus. That number decreases to 574 words at around clock cycle 150. At around clock cycle 150, the compression mechanism 150 will begin putting a word per cycle into the FIFO 152, while at the same time the video-in bus is taking a byte per cycle out of the FIFO 152. This causes the FIFO 152 to grow until clock cycle 798, at which time the compression mechanism 150 stops putting data into the FIFO. Also, the DPR can not be used in straight DPR mode as the data will be overwritten. It would be acceptable to have a ping-pong DPR, where data is written into one side while being taken out of the other side. If a true FIFO were used, that would require four 512-byte FIFOs. If a ping-pong DPR were used, it would require four 512-byte DPRs.

Once the data for a frame is completely inside the SDRAM on the video bus, it will then be transferred to the remote side 126 via the wireless data link 134. Data is streamed out of the processor 142 to the wireless card 146 using the PCI bus 144. Preferably the wireless card 146 is a bus master and so is able to read the data packets straight out of the SDRAM. This requires that the processor 142 and the wireless card 146 share the bus 144, since the wireless card requires the bus on the order of every 32 PCI clock cycles. Therefore, the FPGA-to-processor transfer over the PCI bus 144 has to be able to tolerate considerable latency. Experimental evidence shows that 1,024 bytes per horizontal line on both remote and local ends can be reliably transferred during normal operation.

The local FPGA 138 does not require that the data be transferred before the next line arrives because of the use of the FIFO. The line only needs to be transferred before the FIFO becomes full. The amount of latency that the system can tolerate is a function of the size of the FIFO. The FPGA 138 has memory elements that are 512 bytes in size, and the PCI bus 144 requires that data be transferred in 32-bit sizes. Therefore the minimum size of the buffer is 2,048 bytes, 32 bits wide. 2,048 bytes will accommodate almost three lines of the worst case pattern before the FIFO becomes full. It is also possible to double the FIFO size to 4,096 bytes, which is almost 6 lines of data in the worst case pattern. The number of available RAMs in the FPGA may be a limiting factor. For example, in one Xilinx FPGA used, a limiting factor was the fact that there are only fourteen (14) 512 Byte RAMs available in the FPGA. The local side also requires a FIFO, since the data is coming out of the compression mechanism sixteen bits at a time, up to sixteen bits per pixel clock, and the video-out bus is only able to put out a single 8-bit sample per pixel clock.

The Compression Algorithm

The compression is designed to remove noise from the analog capture and to produce a significant compression (on the order of five to ten times) using a simple horizontal linear algorithm that may be implemented in the FPGA. The preferred algorithm uses a single pass and uses very little temporary storage. Additionally, the algorithm operates on bytes of data (not at the bit level). This approach simplifies encoding and decoding for the FPGA and the processor, at the sacrifice of a little compression.

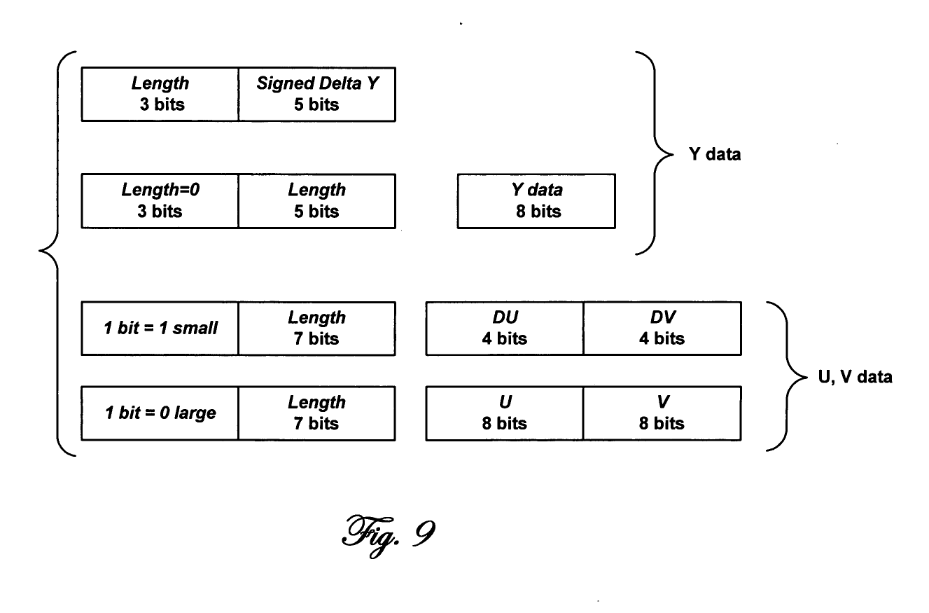

The algorithm uses the following steps:
First, convert the RGB image data into YUV color space
Process Y and UV data in two separate groups
Line fit the data and store only the endpoints
Pack data into the formats shown in FIG. 9, using relative coordinates.

In this compression method, data points are tested to see if they are needed or can be recreated using linear interpolation. The system performs the following steps with respect to a series of data points:
1. Compute the slope from the start point to the test point (second point)
2. Use inverse multiply to avoid division:
   NewSlope=dy×inv[dx]
3. Check to see if Slope (NewSlope) is between a maximum (MaxSlope) and minimum (MinSlope) slope value.
4. If not true, go to step 7
5. If true:
   a. Compute minimum and maximum slopes that go through the minimum and maximum error tolerance points
      (y[2]+2, y[2]−2)
   b. NewMinSlope=(dy−2)*inv[x]=NewSlope−2inv[x]
   c. NewMaxSlope=(dy+2)*inv[x]=NewSlope+2*inv[x]
   d. If NewMaxSlope<MaxSlope
      MaxSlope=NewMaxSlope
   e. If NewMinSlope>MinSlope
      MinSlope=NewMinSlope
6. proceed to next data point and start process over at step 1
7. Use the last point as an endpoint for the line and start point for the next iteration.

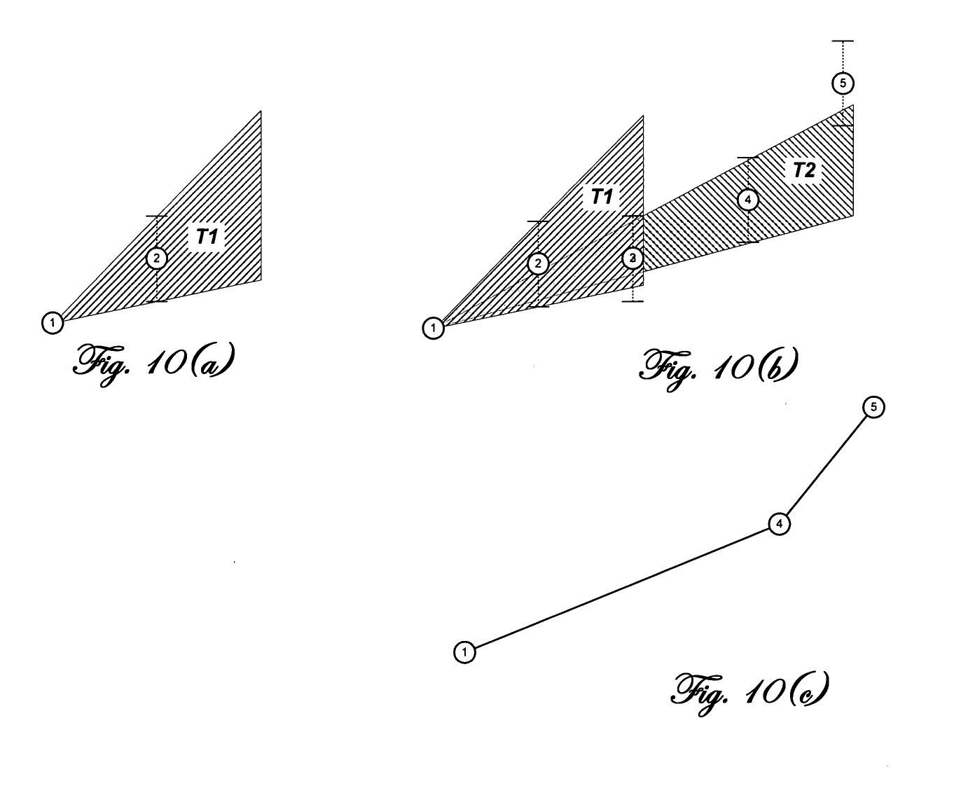

For example, with reference to FIGS. 10(a)-10(c), the first point is point “1” and the second point is point “2”. The maximum (Y value of point 2+2) and minimum (Y value of point 2−2) slopes define a triangle P1. The right side of the triangle T1 is defined by the X value of the next point. Any collinear points will lie within the triangle T1. Then, in FIG. 10(b), point “3” is added and new slope (from points “1” to “3”) is computed. If the new slope is not within the triangle T1 then treat the new point (here “3) as a new endpoint and continue to the next point, otherwise, if the new slope is within the triangle T1 (i.e., is within the previous maximum and minimum slopes), then compute new maximum and minimum slopes (here corresponding to the triangle T2). Any further collinear points will be within triangle T2. In the example shown, the resultant line segments are defined by the points “1”, “4” and “5”, as shown in FIG. 10(c).

This process is used to determine which data points can be calculated (on the remote side) using linear interpolation and therefore do not need to be transmitted from the local unit to the remote unit. If the calculated slope between two data points falls within the predetermined range, the system will continue to perform iterations of the above algorithm to determine how many data points lie on a particular slope. This effectively compresses the amount of data the local unit has to send to the remote unit because the local unit can send the linear interpolation data for the remote unit to decode, which require sending less data than the original pixel data. However, if the data can not be linearly interpolated, all of the pixel data will have to be transmitted, but the system will continue to check to see if the data can be compressed.

This process produces two segment code types, an absolute (“ABS”) segment representing a single pixel encoding the top five bits of each color component totaling 15 bits and a relative (“REL”) segment representing a sequence of pixels of length 2 to length 9 encoding the length in three bits and the relative endpoint in four signed bits for each of red, green and blue. The relative endpoint is computed using pixel component differences using the top six bits of each component. A sixteenth bit in the first bit position distinguishes between the absolute and relative formats.

In some embodiments, this video compression system implements prior-frame compression, but could use the same strategy to implement compression based on the previous line in the current frame. Additionally, the FPGA implementation of the linear fit algorithm incorporates several additional advantageous features. For example, after implementing the test for curvature less than a programmable threshold, gate delays in the FPGA do not permit a simple real time implementation of the computations necessary to create the elements of a relative segment before they need to be output. The relative segment components can not be directly pre-computed because they depend on whether a decision is made in the immediately prior pixel to emit a relative or absolute segment. The current implementation computes three different versions of difference criteria and three different versions of the next segment to be output, knowing that one of the versions will be required. However, the version that is required is not known until the previous segment decision is made.

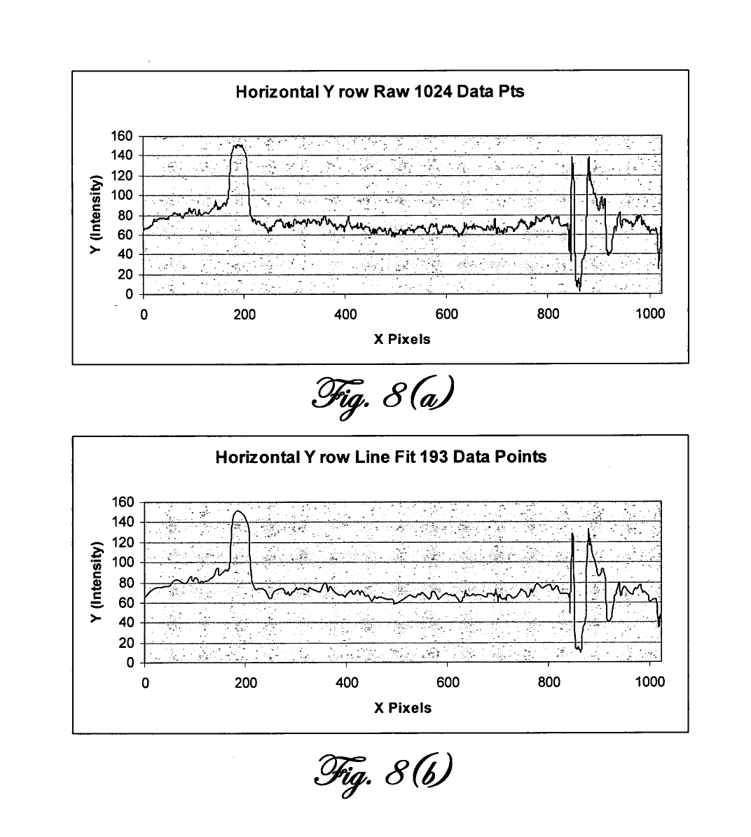

Sample compression factors are shown by the graphs in FIGS. 8(a) and 8(b). As can be seen from the graphs, 1,024 raw data points may be compressed to 193 data points.

Data Packet Format

The beginning of each compressed line on the Video In port will be at least one absolute line segment to start the line. In some preferred embodiments, the data in the SDRAM 140 comes in from the Video In bus will be a sequence of data elements as follows:
[Example: first line has 115 segments]
ABS
[REL or ABS]
[REL or ABS] (115th segment)
[Example: second line has 800 segments]
ABS→Address=115*2
[REL or ABS]
[REL or ABS]
[REL or ABS] (650th segment)
[Example: Third line has 115 segments]
ABS→Address=115*2+650* 2
[REL or ABS]
[REL or ABS]
[REL or ABS[ (115th segment)
Example: Fourth line has 115 segments
ABS
[REL or ABS]
[REL or ABS] (115th segment).

Note that the address of the first line offset is zero. The address of the beginning of the second line could be any number between 115*2 and 1300*2 (where 1,300 is the value that the TM1300 processor 142 programmed into the FPGA 138 to tell how many clock cycles per line exist). The address of the second line cannot be more than 1,344 because the remote side is only able to send 1,344 bytes per line due to the fact that it has 1,344 pixels per line. Note that the lower limit is a function of the maximum relative size of the relative line segments, and the upper limit is a function of the number of pixel clocks per line on the local side, with the final limit of 1,344 due to the number of pixel clocks available on the remote side.

When the FPGA 138 cannot fit all of the data from a line into the video in bus, then it will put the extra data into the FIFO 154 that is connected to the PCI bus 144. In some embodiments this FIFO is located at base address BAR0. On the local side, “BAR0” refers to a base address register that defines the start of a read only FIFO (FIFO 154) containing the extra compressed segments that will not fit into the bandwidth on the video-in bus. When reading the BAR0 FIFO 154, thirty two (32) bits are read at a time, which corresponds to two compressed pixels. In preferred embodiments, the FPGA must put in an even number of pixels at a time into the FIFO. If there are an odd number of pixels, the FPGA should pad the last one, e.g., with 0000, in order to make the number of compressed pixels be even.

An example of the layout of the data is the FIFO is as follows:
[ABS or REL] (line 1, element 651)
[ABS or REL] (line 1, element 652)
[ABS or REL] (line 1, element 653)
[ABS or REL] (line 1, element 654)
[ABS or REL] (line 1, element 655)
0000 (line 1, pad to a even 6 pixels)

In order to determine how many segments are on each line, there is a second FIFO 155 in the local FPGA, located at base address BAR1 (the “BAR1” base address register, for the local side, refers to the start address of a read-only FIFO 155 that contains the number of compressed data elements for the line). The FPGA inserts a sixteen bit value into this FIFO 155 at the end of each line that is the number of compressed data segments on that line. The TM1300 processor then calculates from this value how many compressed pixels are in the BAR0 FIFO 154. For example, in the previous example, there were 115, 655, 115 and 115. Therefore, in that example, the BAR1 FIFO 154 will contain 115, 655 in the first 32 bits, then 115, 115 in the next (second) thirty two bits. Note that the processor must note that 655 is greater than the maximum number of 650 pixels, and there the system can determine that there are five compressed segments in the FIFO 154 for line 2. The system can also ascertain that there is a single “0000” to pad the number of data elements to an even number. The system can then use direct memory access (DMA) to get the six segments (three 32-bit reads) out of the BAR0 FIFO 154 into the processor in order to have the complete lines.

The BAR0 and BAR1 FIFOs 154, 155 will be reset just before the active pixels start on the 26th line. That is, preferably the FIFOs are not reset when the VS pulse occurs, but instead a certain number of lines (VS_BACK_PORCH_WIDTH lines) after the VS pulse. The gives the system many lines (on the order of twenty six lines in the presently preferred embodiment) to clear the FIFOs of all of the frame data, while ensuring that the FIFOs are reset every line.

Having two FIFOs makes the FPGA easy to design, since data just needs to be stacked into one FIFO, while the number of compressed pixels per line is stored in the other FIFO. This design also makes operation of the TM1300 processor easier, since it can easily calculate how many pixels to get out of the PCI BAR0 FIFO 154.

Configurations

Local unit 116 may be configured as a standalone local unit and an accelerated graphics port and/or PCI-based graphics board unit. The standalone local unit and graphics board unit are substantially the same in functionality, excepting that the graphics board unit is a complete graphics board that can be installed into an accelerated graphics port or PCI slot inside the local (target) computer, whereas the standalone local unit is mounted external to the local computer, and does not include the video graphics functions of an IBM-compatible computer. Thus, the standalone local unit must digitize analog video sourced from a third party graphics board installed in the computer, whereas the graphics board unit has direct access to digital video data. The graphics board unit, however, must convert the digital video data to an analog form to provide a slave analog video connector, whereas the standalone local unit must only buffer the existing incoming analog video data with a unity gain amplifier.

There are presently two types of primary remote units 126, the standalone remote unit and the flat panel display unit. The standalone remote unit and flat panel display unit are substantially the same in functionality, excepting that the flat panel display unit is designed to mount inside a display and will typically provide video data in a digital form, whereas the standalone remote unit may be designed to mount external to a video display and may provide video data in an analog form.

The standalone local unit may be connected to the remote computer 104 and may perform as the radio interface device for the computer. Therefore, it acts as the transmitter for video and audio data sourced by the computer, and also acts as the receiver for keyboard and mouse data sourced by remote devices. The standalone local unit also contains three connectors to allow a local monitor, mouse and keyboard to be directly connected to it.

The standalone local unit is responsible for responding as a mouse and keyboard to the remote computer, such that the computer performs as though it had a mouse and keyboard directly attached. Additionally, the standalone local unit digitizes video data from the computer, filters that data and then compresses it using one a group of compression algorithms. Further, the standalone local unit digitizes audio data from the computer, links to an standalone remote unit or flat panel display unit via radio, sends video and audio data to the standalone remote unit or flat panel display unit currently linked to it, receives mouse and keyboard data from the unit currently linked to it. Further, the standalone local unit receives data from a mouse and keyboard directly connected to the standalone local unit and sources mouse and keyboard data to the computer based on the mouse and keyboard data it receives from both the remote mouse and keyboard, and from the locally connected mouse and keyboard. Additionally, the standalone local unit is responsible for providing a local copy of the analog video data from the computer that may be used to drive a locally connected monitor.

The graphics board unit is installed inside the computer and performs as both the graphics display adapter for the computer and as the radio interface device. It performs the task as the transmitter for video and audio data source by the computer and acts as the receiver for keyboard and mouse data sourced from remote devices. Additionally, the graphics board unit performs all of the standard video graphics functions of a computer graphics board. The graphics board unit contains a short captive multi-cable assembly that is used to receive keyboard, mouse and audio data from the computer. This cable may terminate in industry standard connectors that are designed to plug into the appropriate sockets in the computer chassis. The graphics board unit also contains three connectors to allow an external local monitor, mouse and keyboard to be directly connected to it.

In some embodiments, the graphics board unit also performs at least some of the following actions: It responds as a mouse and keyboard to the computer, such that the computer performs as though it had a mouse and keyboard directly attached. It performs as the video graphics adapter for the computer. It takes digitized video data from the video graphics adapter, filters that data and then compresses it using one of a group of compression algorithms. It also digitizes the audio data from the computer and links to an standalone remote unit or flat panel display unit via radio. Additionally, it sends video and audio data to the standalone remote unit or flat panel display unit currently linked to it and receives mouse and keyboard data from the remote unit currently linked to it. It also receives data from a mouse and keyboard directly connected to the graphics board unit and sources mouse and keyboard data to the computer based on the mouse and keyboard data it receives from both the remote mouse and keyboard, as well as from the locally connected mouse and keyboard.

The graphics board unit also provides a local copy of the analog video data from the computer that may be used to drive a locally connected monitor.

The standalone remote unit may be connected to user interface devices and acts as the radio interface for these user interface devices. Therefore, it acts as the receiver for video and audio data sourced from the link and may perform as the transmitter for keyboard and mouse data sourced by the user interface devices. The standalone remote unit further acts to sender user interface devices' data to the standalone local unit or graphics board unit currently linked to it and receive video and audio data from the standalone local unit or graphics board unit currently linked to it. Additionally, it sources video data received via the link, after first decompressing it and converting it to an analog form and sources audio data received via the link, after converting it to an analog form. Further, the standalone remote unit provides an on-screen display (OSD) to the user. The OSD may be used by the user for a variety of functions, including selection of an standalone local unit or graphics board unit with which to establish a link with, adjustment of various parameters, including screen position, clock induced noise and local name, as well as displaying link data for diagnostic purposes.

The flat panel display unit is designed to work in substantially the same manner as the standalone remote unit, however it is designed to mount inside a flat panel display such that it can act as the electrical interface for both the display device and for a backlight assembly, if the display requires one. In addition to the tasks of the standalone remote unit, the flat panel display unit further may have to provide all of the power required by the display device and its associated backlight.

The local unit 116 and the remote unit 126 are coupled via a radio link. They remain linked until the remote unit 126 sends a disconnect command. However, once a link is established between a local unit and a remote unit, the local unit may not attempt to link to a different and separate remote unit until a time when it is no longer linked. It may, however, continue to respond to polls from other remote units.

If the link between a remote unit and a local unit is broken, the local unit and the remote unit participating in the link may always attempt to re-establish the link, except in the case that the link is broken by a disconnect command from the remote unit. This may also apply in the case that either the local unit or the remote unit is reset or has its power cycled. There may be no timeout on attempts to re-establish the link. However, if a link is broken, the local unit may discontinue its attempts to re-establish the link and respond to a link request from a separate and different remote unit.

In other embodiments of the invention, a so-called “turbo” mode is used with respect to the radio link. In turbo mode, the local and remote units can be used simultaneously to increase the data throughput of the link. However, the link is always initially established using the non-turbo mode of the radio. If the link statistics show that the performance of the link is sufficient, the remote unit may command the local unit to switch into turbo mode. If the link can not be maintained in turbo mode, the remote unit may command the local unit to switch back to non-turbo mode, and may not try to re-establish turbo mode for the remainder of the duration of the link.

Once the link has been established, however, data may be sent in both directions. The local unit may send video data and audio data to the remote unit, and the remote unit may send keyboard and mouse data to the local unit. Additionally, in certain circumstances, it may be necessary to set up a system where multiple remote units can receive data from one local unit simultaneously. This is referred to as broadcast mode. In this mode, one remote unit may be designated as the master remote unit and all other remote units participating in the broadcast mode as slave remote units. The master remote unit may be responsible for maintaining the link, whereas the slave remote units may not participate in the link function other than to receive data without acknowledgement.

In some embodiments of the invention, the OSD has the capability to drive a special set of screens on the display attached to the remote unit for control, information and diagnostic purposes. The OSD has a plurality of menus that can be navigated using the remote keyboard or mouse. In certain embodiments of the invention, the main menu of the OSD will have five selection options, namely: select source computer, display configuration, source computer configuration, calibration and diagnostics, exit OSD.

In some embodiments, the first menu option (“select source computer”) identifies and displays all the local units responding to polls from the remote unit. A user may scroll through the choices and select the appropriate local unit. After a selection is made, a link with that unit is established and the OSD returns to the main menu. Also, selecting the “select source computer” menu option always disconnects any presently connected local unit. After a board reset, the remote unit will display the “select source screen” on the OSD.

The OSD may also allow for the adjustment of certain video parameters. For example, the vertical and horizontal positions of the display may be adjusted, as well as brightness, contrast, frame to frame threshold, and the phase difference between the video clock in the local unit and the video clock in the computer. Further, the OSD can provide for an automatic adjustment setting, where the remote unit will perform the adjustments itself.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. In a wireless keyboard, video, mouse (KVM) system, a method of transmitting video signals, comprising:
converting analog video data from RGB signals to YUV signals;
compressing the YUV signals; and
providing the compressed YUV signals.

2. A method as in claim 1 wherein Y signals of the YUV signals and UV signals of the YUV signals are processed in two groups.

3. A method as in claim 1 wherein the compressing comprises:
compressing the Y and UV data using a linear interpolation algorithm, and wherein the compressed YUV signals represent line segments.

4. A method as in claim 3 further comprising:
providing at least some of the endpoints using relative coordinates.

5. A method as in claim 1 wherein the RGB video signals are represented by 24 bits, the YUV signals are represented by 24 bits and at least some compressed YUV signals are represented by 16-bit line segments.

6. In a wireless keyboard, video, mouse (KVM) system, a method of processing video signals, comprising:
obtaining a compressed YUV signal;
decompressing the compressed YUV signal to obtain a YUV signal; and
converting the YUV signal to an RGB signal.

7. A method as in claim 6 wherein the compressed YUV signals represent line segments.

8. A method as in claim 7 wherein the RGB video signals are represented by 24 bits, the YUV signals are represented by 24 bits and at least some compressed YUV signals are represented by 16-bit line segments.
